(19) United States
(12) Patent Application Publication
(10) Pub. No.: US 2022/0254042 A1
(43) Pub. Date: Aug. 11, 2022

(54) METHODS AND SYSTEMS FOR SENSOR UNCERTAINTY COMPUTATIONS

(71) Applicant: GM GLOBAL TECHNOLOGY OPERATIONS LLC, Detroit, MI (US)

(72) Inventors: Prachi Joshi, Sterling Heights, MI (US); Lawrence A. Bush, Shelby Township, MI (US)

(73) Assignee: GM GLOBAL TECHNOLOGY OPERATIONS LLC, Detroit, MI (US)

(21) Appl. No.: 17/174,083

(22) Filed: Feb. 11, 2021

(51) Int. Cl. G06T 7/50; G06T 7/11; B60W 60/00

(52) U.S. Cl. CPC G06T 7/50; B60W 2420/403; B60W 60/001; G06T 7/11

(57) ABSTRACT

Systems and method are provided for controlling a sensor of a vehicle. In one embodiment, a method includes: receiving depth image data from the sensor of the vehicle; computing, by a processor, an aleatoric variance value based on the depth image data; dividing, by the processor, the depth image data into grid cells; computing, by the processor, a confidence bound value for each grid cell based on the depth image data; computing, by the processor, an uncertainty value for each grid cell based on the confidence bound value of the grid cell and the aleatoric variance value; and controlling, by the processor, the sensor based on the uncertainty values.

### TECHNICAL FIELD

The present disclosure generally relates to vehicles, and more particularly relates to systems and methods for determining uncertainty values sensors of a vehicle, such as an autonomous vehicle.

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While autonomous vehicles offer many potential advantages over traditional vehicles, in certain circumstances it may be desirable for improved operation of autonomous vehicles, such as usage of lidar point cloud data. For example, sensors may be adapted to accommodate for errors. Uncertainty of a sensor measurement is computed in order to adapt the sensor. Accuracy of the uncertainty values improves sensor values and overall vehicle control. Accordingly, it is desirable to provide improved systems and methods for computing uncertainty of sensor measurements.

### SUMMARY

Systems and methods are provided for controlling an autonomous vehicle. In one embodiment, a method for controlling a sensor of a vehicle includes: receiving depth image data from the sensor of the vehicle; computing, by a processor, an aleatoric variance value based on the depth image data; dividing, by the processor, the depth image data into grid cells; computing, by the processor, a confidence bound value for each grid cell based on the depth image data; computing, by the processor, an uncertainty value for each grid cell based on the confidence bound value of the grid cell and the aleatoric variance value; and controlling, by the processor, the sensor based on the uncertainty values.

In various embodiments, the controlling includes controlling the sensor internally or externally to reduce the uncertainty in a region corresponding to a grid cell.

In various embodiments, the computing the aleatoric variance value is based on prior variance, a current variance, and a weighted exponential decay.

In various embodiments, the computing the aleatoric variance value is based on a prior variance, a current variance, and a change detection.

In various embodiments, the computing the aleatoric variance value is based on a combination of epistemic variance and aleatoric variance. In various embodiments, the method includes: determining an exponential rate of decay in belief factor; and applying the exponential rate of decay in belief factor to the confidence bound value to determine a decayed variance, and wherein the computing the uncertainty value is based on the decayed variance.

In various embodiments, the determining the exponential rate of decay in belief factor is performed for each grid cell of the depth image.

In various embodiments, the determining the exponential rate of decay in belief factor is determined based on a matrix of values between zero and one.

In various embodiments, each value of the matrix is the same.

In various embodiments, one or more of the values of the matrix are different.

In various embodiments, the method further includes computing, by the processor, a count of a number of times the sensor was tasked to sense the grid cell, and wherein the computing the uncertainty for each grid cell is based on the count.

In another embodiment, a system for controlling a sensor of a vehicle includes: non-transitory computer readable medium configured to perform, by a processor, a method, the method comprising: receiving depth image data from the sensor of the vehicle; computing, by a processor, an aleatoric variance value based on the depth image data; dividing, by the processor, the depth image data into grid cells; computing, by the processor, a confidence bound value for each grid cell based on the depth image data;

computing, by the processor, an uncertainty value for each grid cell based on the confidence bound value of the grid cell and the aleatoric variance value; and controlling, by the processor, the sensor based on the uncertainty values.

In various embodiments, the controlling comprises, controlling the sensor at least one of internally and externally to reduce the uncertainty in a region corresponding to a grid cell.

In various embodiments, the computing the aleatoric variance value is based on prior variance, a current variance, and a weighted exponential decay.

In various embodiments, the computing the aleatoric variance value is based on a prior variance, a current variance, and a change detection.

In various embodiments, the computing the aleatoric variance value is based on a combination of epistemic variance and aleatoric variance.

In various embodiments, the method further comprises determining an exponential rate of decay in belief factor; and applying the exponential rate of decay in belief factor to the confidence bound value to determine a decayed variance, and wherein the computing the uncertainty value is based on the decayed variance.

In various embodiments, the determining the exponential rate of decay in belief factor is performed for each grid cell of the depth image.

In various embodiments, the determining the exponential rate of decay in belief factor is determined based on a matrix of values between zero and one.

In various embodiments, the method further comprises computing, by the processor, a count of a number of times the sensor was tasked to sense the grid cell, and wherein the computing the uncertainty for each grid cell is based on the count.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a dataflow diagram illustrating an uncertainty determination system for an autonomous vehicle, in accordance with various embodiments; and

FIG. 5 is a flowchart illustrating a method of computing uncertainty values and controlling the autonomous vehicle based thereon, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

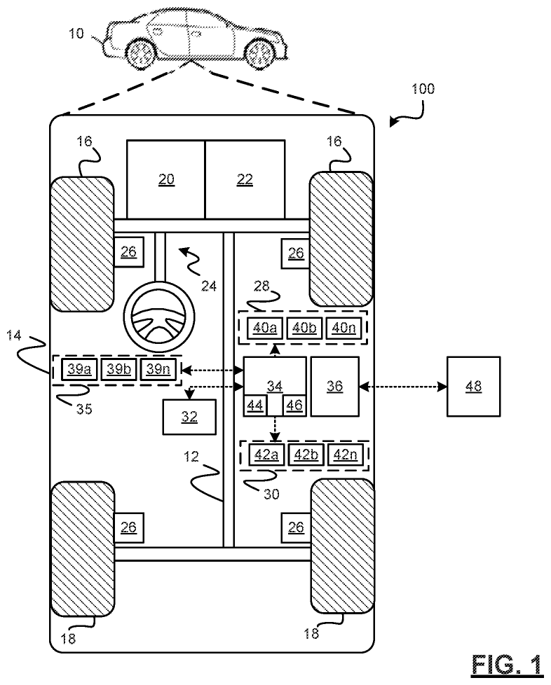

With reference to FIG. 1, an uncertainty determination system shown generally as 100 is associated with a vehicle 10 in accordance with various embodiments. In general, the uncertainty determination system (or simply “system”) 100 computes an uncertainty and/or a rate of decay in belief of a scene or scenario provided by sensor measurements. The resulting values are then used by the vehicle 10 to control one or more functions of the vehicle 10.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the uncertainty determination system 100, and/or components thereof, are incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any autonomous or other vehicle that utilizes a navigation system and/or other systems to provide route guidance and/or implementation.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n might include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

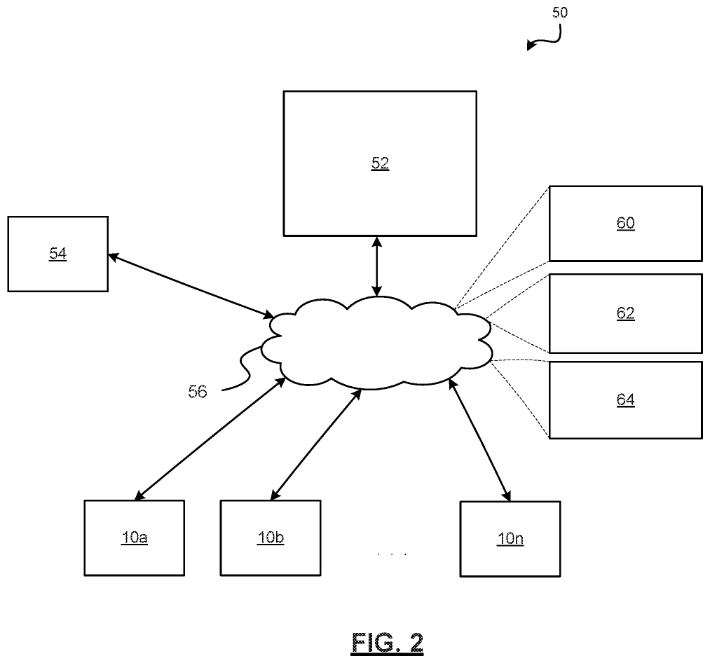

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10. In various embodiments, as discussed in detail below, the controller 34 is configured to compute uncertainty values and/or rate of decay in belief values and controls the autonomous vehicle 10 based thereon.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, and the like) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62 but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information. In one embodiment, as described in further detail below, remote transportation system 52 includes a route database 53 that stores information relating to navigational system routes, including lane markings for roadways along the various routes, and whether and to what extent particular route segments are impacted by construction zones or other possible hazards or impediments that have been detected by one or more of autonomous vehicles 10a-10n.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

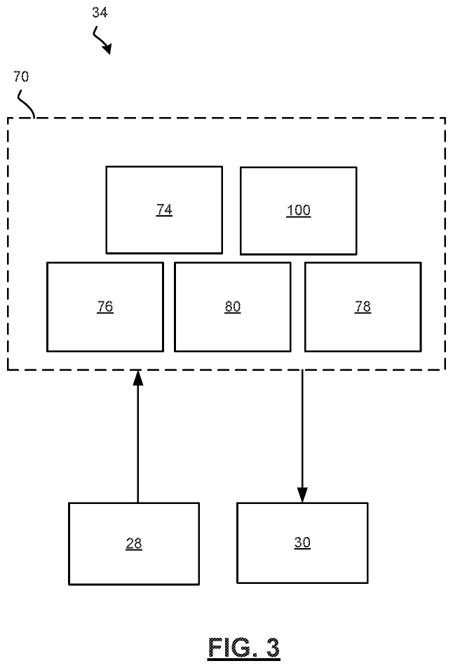

In accordance with various embodiments, the controller 34 implements an autonomous driving system (ADS) as shown in FIG. 3. That is, suitable software and/or hardware components of the controller 34 (e.g., processor 44 and computer-readable storage device 46) are utilized to provide an ADS that is used in conjunction with vehicle 10.

In various embodiments, the instructions of the autonomous driving system 70 may be organized by function or system. For example, as shown in FIG. 3, the autonomous driving system 70 can include a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, lidars, radars, and/or any number of other types of sensors. In various embodiments, the sensor fusion system 74 implements the uncertainty determination system 100 and methods disclosed herein.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path. In various embodiments, the sensor fusion system 74 and/or the vehicle control system 80 implements and/or coordinates information with the uncertainty determination system 100 and methods disclosed herein.

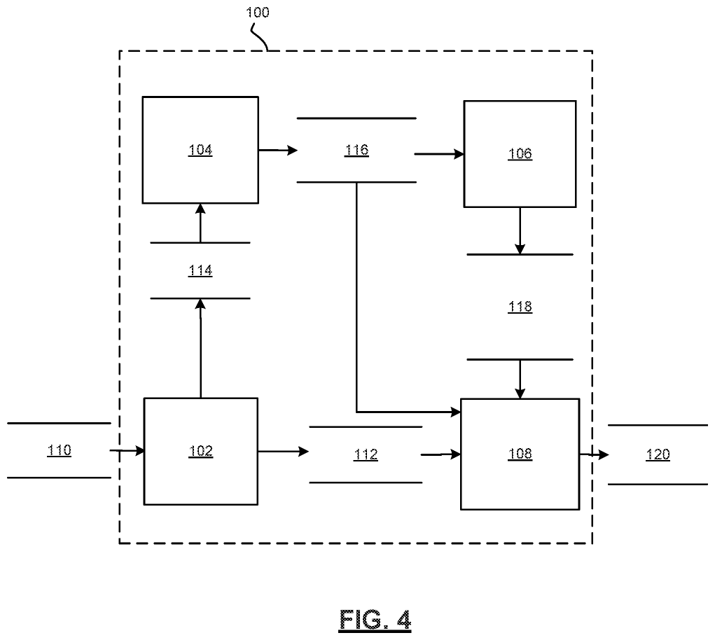

In that regard, FIG. 4 is a dataflow diagram illustrating aspects of the uncertainty determination system 100 in shown in more detail. It will be understood that the sub-modules shown in FIG. 4 can be combined and/or further partitioned to similarly perform the functions described herein. Inputs to modules may be received from the sensor system 28, received from other control modules (not shown) associated with the autonomous vehicle 10, received from the communication system 36, and/or determined/modeled by other sub-modules (not shown) within the controller 34 of FIG. 1. The modules shown generally perform the functions of computing uncertainty values and/or rate of decay in belief values and using the computed values to selectively control sensors of the autonomous vehicle 10. In various embodiments, the modules include an aleatoric variance determination module 102, a confidence bound determination module 104, a decay in belief computation module 106, and an uncertainty computation module 108.

The aleatoric variance determination module 102 receives depth image data 110 corresponding to sensor measurements provided by, for example, a lidar or radar of the vehicle 10. In various embodiments, the aleatoric variance determination module 102 computes an instantaneous aleatoric variance (AV(t)) based on the depth image data 110 and produces aleatoric variance data 112 based thereon.

For example, the aleatoric variance determination module 102 determine the instantaneous aleatoric variance by first dividing the depth image of the depth image data 110 into grid cells, for example, to produce grid depth data 114. As can be appreciated, the grid cells can be a predefined size, for example, corresponding to sensor parameters and/or can be adjustable in size based on the amount of data in the depth image or other parameters.

For each grid cell, the aleatoric variance determination module 102 aggregates the sensor samples within the cell, determines a line of sight (LoS) distance from the sensor samples, and computes a Gaussian mean and variance of the LoS distances. In various embodiments, the aleatoric variance determination module 102 then computes the final aleatoric variance based on a weighted exponential decay, a change detection, and/or a combination of epistemic and aleatoric variances. For example, the aleatoric variance determination module 102 can compute the aleatoric variance of the depth image using a prior variance (AV(t−1)), a current variance (AV(t)), and a weighted exponential decay (D) as:

AV=W1*AV(t−1)+W2*AV(t).

In another example, the aleatoric variance determination module 102 can compute the aleatoric variance of the depth image using a prior variance (AV(t−1)), a current variance (AV(t)), and a change detection as:

AV=|AV(t)−AV(t−1)|.

In yet another example, the aleatoric variance determination module 102 can compute the aleatoric variance of the depth image using a combination of epistemic variance (EV) and aleatoric variance (AV) as:

AV(t)=EV(t)+AV(t).

As can be appreciated, the aleatoric variance can be computed according to any number of different methods. Embodiments of the disclosure are not limited to any one of the present examples.

The confidence bound determination module 104 receives the grid depth data 114. The confidence bound determination module 104 computes a confidence bound value for each grid cell in the depth image to produce confidence bound data 116. The confidence bound indicates the confidence in the measurement of knowledge of the scene and can be computed for each cell (i, j) at each time instant (t) as:

CB(i,j)=\sqrt{2 log(N)/a_n},

where N represents the total number of iterations and a_n represents the number of iterations when a grid cell ‘a’ was sensed by tasking from the beginning of the loop. A large confidence bound shows high uncertainty; a low confidence bound shows low uncertainty. The confidence bound determination module 104 provides task count data 118 based on the count a_n.

In various embodiments, the rate of decay determination module 106 receives the confidence bound data 116 and the task count data 118. The rate of decay determination module 106 computes an exponential rate of decay in belief for each cell of the depth image and applies the computed rate of decay to the confidence bound value of the cell to determine variance data 120 for each cell of the depth image.

For example, when a grid cell is not sensed, the corresponding belief decays. This decay is not necessarily constant. An exponential decay factor (DF) can be computed as:

DF=μ*μ\hat{ }|(AV(t−1)−AV(t))|,

where μ is a constant matrix of values between zero and one, and μ can be the same for each cell or different. The uncertainty computation module 108 then multiplies the computed decay factor with the confidence bound values.

In various embodiments, the uncertainty computation module 108 receives the aleatoric variance data 112, the variance data 120 including the decayed confidence bound values, and the task count data 118. For each grid cell in the depth image, when the task count of the task count data 118 is greater than zero (that is the amount of times the cell has been tasked to sense), the uncertainty computation module 108 computes the uncertainty as:

U(t)=W1*AV(i,j,)(t)+W2*CB(i,j).

When the task count of the task count data is zero, the uncertainty computation module 108 sets the uncertainty value for the grid cell to a default value.

Once all cells have been processed of the depth image, the uncertainty data 122 is analyzed to determine how to task the sensors of the sensor system 28.

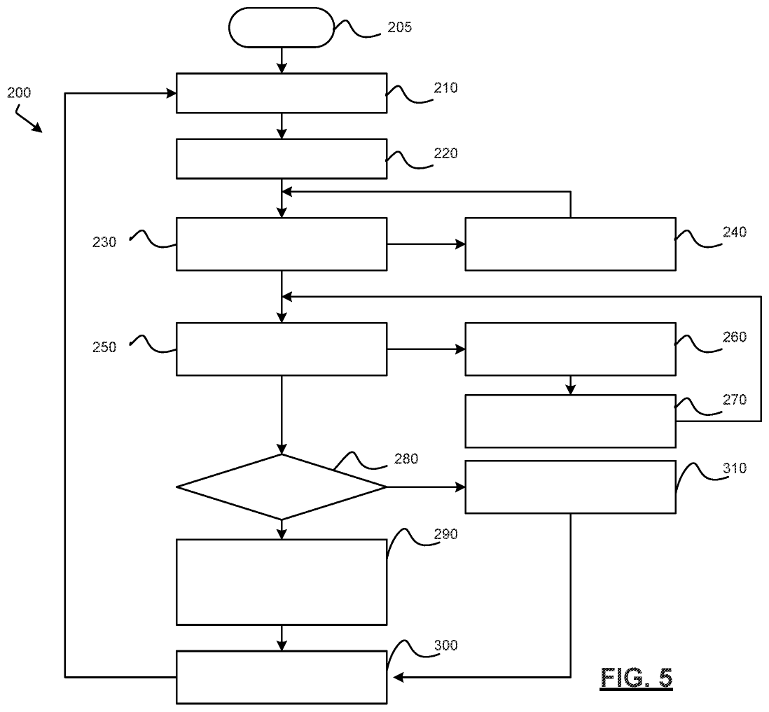

Referring now to FIG. 5 and with continued reference to FIGS. 1-4, a flowchart illustrates a method 200 for computing uncertainty and the rate of decay in belief values and controlling on or more components of the autonomous vehicle 10 based thereon, in accordance with various embodiments. As can be appreciated in light of the disclosure, the order of operation within the method 200 is not limited to the sequential execution as illustrated in FIG. 5 but may be performed in one or more varying orders as applicable and in accordance with the present disclosure. In various embodiments, the method 200 can be scheduled to run based on one or more predetermined events, and/or can run continuously during operation of the autonomous vehicle 10.

In one example, the method 200 may begin at 205. Depth image data at time (t) is received at 210. The instantaneous aleatoric variance at time (t) is computed for example, using one of the exemplary computational methods as described above at 220.

Thereafter, for each grid cell in the depth image at 230, the confidence bound data is computed at time (t), for example, using the methods as described above at 240.

Thereafter, for each cell in the depth image at 250, an exponential rate of decay in belief is computed at 260 and applied to the confidence bound at each cell at 270. Thereafter, the sensed count is evaluated at 280. When the sensed count is greater than zero at 280, the uncertainty is determined from a weighted sum of the cell aleatoric variance and the cell confidence bound at 290. When the sensed count is zero, the cell is padded with a default uncertainty value (e.g., a large value) at 300. Thereafter, one or more sensors of the sensor system 28 are tasked (internally or externally) based on an evaluation of the uncertainty data in the cells of the image at 310. For example, the sensors are tasked where expected uncertainty reduction improves decision the most. In various embodiments, the method 200 may continue to iterate while the sensors are operational.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling a sensor of a vehicle, the method comprising:
receiving depth image data from the sensor of the vehicle;
computing, by a processor, an aleatoric variance value based on the depth image data;
dividing, by the processor, the depth image data into grid cells;
computing, by the processor, a confidence bound value for each grid cell based on the depth image data;
computing, by the processor, an uncertainty value for each grid cell based on the confidence bound value of the grid cell and the aleatoric variance value; and
controlling, by the processor, the sensor based on the uncertainty values.

2. The method of claim 1, wherein the controlling comprises, controlling the sensor internally or externally to reduce the uncertainty in a region corresponding to a grid cell.

3. The method of claim 1, wherein the computing the aleatoric variance value is based on prior variance, a current variance, and a weighted exponential decay.

4. The method of claim 1, wherein the computing the aleatoric variance value is based on a prior variance, a current variance, and a change detection.

5. The method of claim 1, wherein the computing the aleatoric variance value is based on a combination of epistemic variance and aleatoric variance.

6. The method of claim 1, further comprising determining an exponential rate of decay in belief factor; and
applying the exponential rate of decay in belief factor to the confidence bound value to determine a decayed variance, and wherein the computing the uncertainty value is based on the decayed variance.

7. The method of claim 6, wherein the determining the exponential rate of decay in belief factor is performed for each grid cell of the depth image.

8. The method of claim 7, wherein the determining the exponential rate of decay in belief factor is determined based on a matrix of values between zero and one.

9. The method of claim 8, wherein each value of the matrix is the same.

10. The method of claim 8, wherein one or more of the values of the matrix are different.

11. The method of claim 1, further comprising computing, by the processor, a count of a number of times the sensor was tasked to sense the grid cell, and wherein the computing the uncertainty for each grid cell is based on the count.

12. A system for controlling a sensor of a vehicle, the system comprising:
non-transitory computer readable medium configured to perform, by a processor, a method, the method comprising:
receiving depth image data from the sensor of the vehicle;
computing, by a processor, an aleatoric variance value based on the depth image data;
dividing, by the processor, the depth image data into grid cells;
computing, by the processor, a confidence bound value for each grid cell based on the depth image data;
computing, by the processor, an uncertainty value for each grid cell based on the confidence bound value of the grid cell and the aleatoric variance value; and
controlling, by the processor, the sensor based on the uncertainty values.

13. The system of claim 12, wherein the controlling comprises, controlling the sensor at least one of internally and externally to reduce the uncertainty in a region corresponding to a grid cell.

14. The system of claim 12, wherein the computing the aleatoric variance value is based on prior variance, a current variance, and a weighted exponential decay.

15. The system of claim 12, wherein the computing the aleatoric variance value is based on a prior variance, a current variance, and a change detection.

16. The system of claim 12, wherein the computing the aleatoric variance value is based on a combination of epistemic variance and aleatoric variance.

17. The system of claim 12, wherein the method further comprises determining an exponential rate of decay in belief factor; and
applying the exponential rate of decay in belief factor to the confidence bound value to determine a decayed variance, and wherein the computing the uncertainty value is based on the decayed variance.

18. The system of claim 17, wherein the determining the exponential rate of decay in belief factor is performed for each grid cell of the depth image.

19. The system of claim 17, wherein the determining the exponential rate of decay in belief factor is determined based on a matrix of values between zero and one.

20. The system of claim 12, wherein the method further comprises computing, by the processor, a count of a number of times the sensor was tasked to sense the grid cell, and wherein the computing the uncertainty for each grid cell is based on the count.
